(19) United States
(12) Patent Application Publication
(10) Pub. No.: US 2014/0304128 A1
(43) Pub. Date: Oct. 9, 2014

(54) METHOD TO CAPTURE EVENT INFORMATION FROM MOBILE DEVICE

(71) Applicant: Pelorus Technology, LLC, Austin, TX (US)

(72) Inventor: Erik Cornet, Austin, TX (US)

(21) Appl. No.: 13/987,322

(22) Filed: Dec. 31, 2012

Related U.S. Application Data
(60) Provisional application No. 61/677,396, filed on Jul. 30, 2012.

(51) Int. Cl. G06Q 40/00

(52) U.S. Cl. CPC G06Q 40/125
USPC 705/32

(57) ABSTRACT

A method to capture parameters related to billable events for the purpose of posting such information to an accounting system. The method includes the steps of capturing a plurality of parameters for the event, wherein one of the parameters is an elapsed time of the event, identifying whether a capture fence applies to the event, permitting the modification of each of the plurality of parameters, and storing the event where the elapsed time is greater than the capture fence.

### FIELD OF INVENTION

The invention generally relates to the field of mobile device software, and in particular to time keeping applications.

### BACKGROUND OF INVENTION

Various professionals, such as legal professionals, must account for and track the time they spend on certain activities for billing purposes. The clients of these types of professional require the profession to accurately provide the client with incremental details of the time spent on various tasks, activities and projects before that client will pay for the professional's services. In the past, professional have keep track of their time using various methods, such as handwritten time sheets, computer spreadsheets and other various means of manual entries. For example, some professional use a computer or a printed calendar, and fill in the tasks and project they perform throughout the day on a such calendar.

The types of manual methods of capturing and tracking time are often, inefficient, inaccurate, and cumbersome. Importantly, relying upon such manual methods can result in a failure to identify each activity performed, or a failure to accurately account for the time spent on each activity. Often, professional are extremely busy, have many different clients and account and have difficulty keeping track of all the time they spend on the various tasks they perform throughout the day. Accordingly, such professionals will lose time by failing to record certain tasks, and in effect are unable to bill their clients for these untracked tasks.

Although some automated processes exist, they do not sufficiently capture all of the various tasks professional perform during the day. Additionally, previous automated processes are not intuitive and easy for professionals to use and do not allow a professional to control the preparation and posting of an event to an automated billing accounting system.

Moreover, because professionals are often performing recordable activities away from their computers, and even outside of their office, professionals will often fail to record time simply because their recordation methods were not locally available when the activity was performed.

Accordingly, there is a need for an automated system to allow professionals to capture every billable task performed during a day, and in effect eliminate “white space” (the time periods on their daily calendar that lack any recorded activities). There is a further need for such a system to enable the professional to access it while away from the office from a mobile device.

### BRIEF DESCRIPTION THE DRAWINGS

FIG. 1 is a flow chart depicting a method of capturing event information from a mobile device.

FIG. 2 is a depiction of a user interface (UI) screen used in a preferred embodiment to capture event information for a manual event.

FIG. 3 is a depiction of a UI screen used in a preferred embodiment to set various parameters to capture event information.

### WRITTEN DESCRIPTION

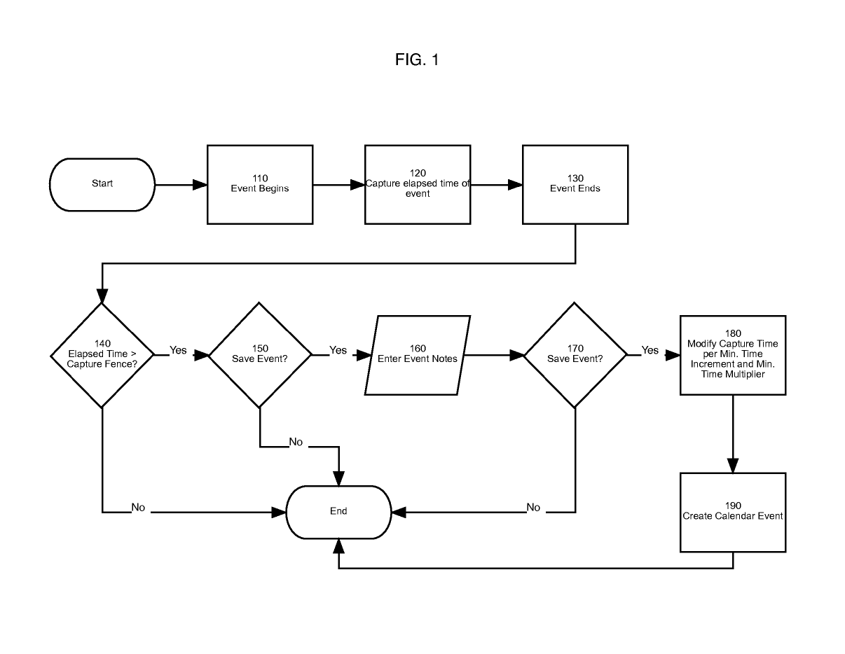

FIG. 1 is a flow chart depicting the various steps in a method of using a mobile device to capture information related to certain events for the purpose of posting such information to an accounting system 100. It will be understood by those skilled in the art that this method 100 is platform independent and thus can be employed on a variety mobile devices, including mobile devices that run the Android, iOS or Microsoft Windows operating systems. The method 100 automatically captures the elapsed time for different types of events, including: phone calls, email reads, email replies, email composition, text message reads, text message replies, and text message composition. The method 100 can also manually capture the elapsed time from manual events. Manual event capture can be utilized to capture event details that are outside of the mobile device, such as a meeting.

Regardless of the type of event for which the elapsed time is captured, the method 100 employs the same steps. FIG. 1 depicts these steps.

The method 100 begins with step 110 which is triggered by the beginning of the event. It is understood by those skilled in the art that the precise trigger for any event may be different depending on the type of the event. For example, if the event is a phone call, then the trigger to begin step 110 might be the click of an “ANSWER” button (for incoming phone calls) or the click of a “SEND” button (for outgoing phone calls). Once the trigger has occurred, processing passes from step 110 to step 120. In the preferred embodiment, the trigger for each of the automatic event is dependent upon the type of event. For example, the trigger for an inbound phone call event is answering the phone call, while the trigger for an outbound phone call event is initiating the outbound phone call (e.g., hitting the “send” or “call” button on the phone).

In step 120 the amount of time that elapses between the beginning of step 110 and the beginning of step 130 is captured. Step 120 ends and step 130 begins upon the occurrence of a second trigger, which may depend upon the type of automatic event being captured. For example, if the automatic event is a phone call, then the second trigger could be the click of an “END CALL” button. In the preferred embodiment, the second trigger for each of the preferred automatic events is dependent upon the type of event of event. For example, for an inbound phone call event, the second trigger is termination of the phone call, while the second trigger for a send email event is initiating the send functionality for the email (e.g., hitting “send” in the email application of the mobile phone). Once the event ends in step 130, processing passes to step 140.

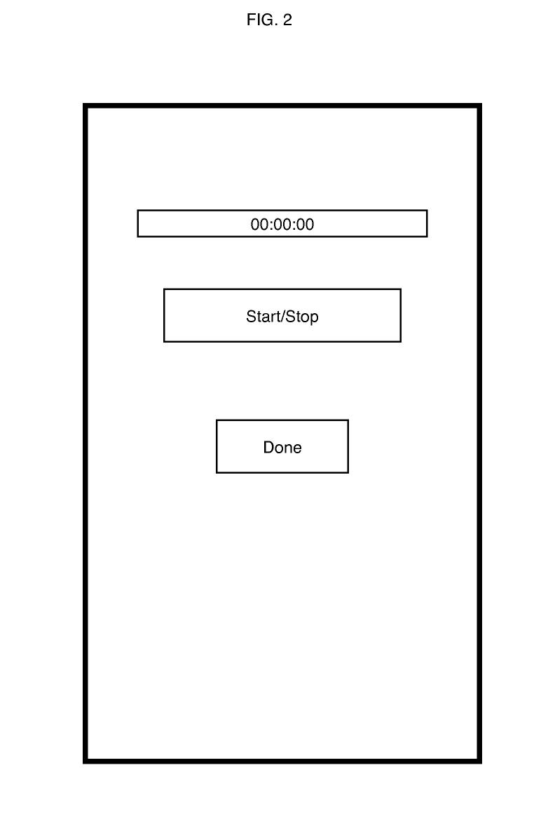

In the case of a manual event, the triggers for steps 110 and 130 occur when the user presses a “START/STOP” button. FIG. 2 depicts a preferred embodiment of a UI on the mobile device for capturing event details of a manual event. The “START/STOP” button is a multi-function button. When the UI form depicted in FIG. 2 is first accessed, the START/STOP button has a green background. Pressing the START/STOP button starts the timer object (depicted above the START/STOP button), triggers step 120 and turns the color of the background of the START/STOP button to red. Pressing the START/STOP button a second time stops the timer object and turns the color of the background back to green. The trigger for step 130 is when the user presses the DONE button.

In step 140, the elapsed time that was captured in step 120 is compared against a capture fence. The capture fence is the number of seconds an event has to elapse in order for the method 100 to capture the event. If the elapsed time for the event is less than the capture fence, then the processing of method 100 will end. If the elapsed time for the event is greater than the capture fence, then processing is passed to step 150. For example, setting the capture fence to ten means that any event; phone call, email, text message, or manual must be at least ten seconds long before the method 100 will capture the event. It should be noted that the capture fence may be configured to be any time period including zero seconds.

In step 250, the user is presented with a choice of choosing to save the event. It will be understood that not all captured events will need to be captured by the method 100. For example, events such as personal phone calls or other non-billable activities cannot be billed to a particular account in the accounting system. Accordingly, the user may choose not to save the event in step 250. In the preferred embodiment, the user is presented with a dialog box asking if the user wishes to save the event. The user may press a “YES” button to indicate a desire to save the event, and may press a “NO” button to indicate that the event should not be saved. If the user indicates that the event should not be saved, then processing for method 100 ends. If, however, the user indicates a desire to save the event, then processing passes to step 160.

In step 160, the user enters in event specific notes that describe the event. In the preferred embodiment, the user is presented with a dialog box that includes a text entry field, a “SAVE” button and a “CANCEL” button. The text entry field may be pre-populated with information related to the event. For example, if the event is an incoming phone call then the text entry field may include the name of the person to whom the user placed the call. The user can then modify or supplement the pre-populated information with additional details about the event. Processing is passed to step 170 when the user hits either the “SAVE” or “CANCEL” buttons.

If the user exited step 160 by pressing the “SAVE” button, then step 170 passes processing to step 180. If the user exited step 60 by pressing the “CANCEL” button, then step 170 ends processing of the method 100.

In step 180, the event elapsed time is modified by analyzing a minimum time increment and a minimum time multiplier. The minimum time increment is the smallest amount of time that should be recorded for any captured event. The minimum time increment is expressed in decimals of an hour, e.g., “0.1”=6 minutes, “0.2”=12 minutes. If the elapsed time of the event is less than the minimum time increment, then elapsed time is rounded up to the value of the minimum time increment. For example, if the minimum time increment is set to “0.1” (6 minutes) and the elapsed time of the event is 5 minutes, then the elapsed time is rounded up to 6 minutes. The minimum time multiplier is the time unit that the elapsed time for an event should be rounded to if: (a) the elapsed time is greater than the minimum time increment; and (b) the quotient of the elapsed time divided by the minimum time increment is not a whole number. For example, if the minimum time multiplier is set to 0.1 and the elapsed time of an event is 8 minutes 25 seconds, then the event will be rounded to “0.2” (12 minutes). After step 180 analyzes and modifies the elapsed time of the event, processing is passed to the step 190.

In step 190, the event is saved to a calendar of the mobile device. Processing for method 100 is then complete.

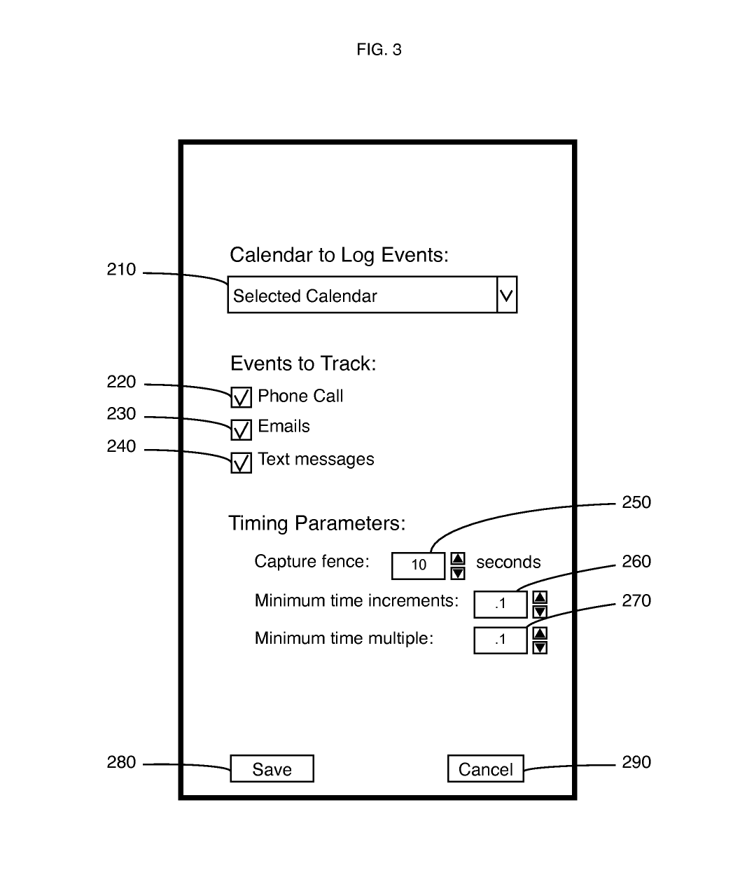

Now referring to FIG. 3, depicted is a preferred embodiment of a UI screen on a mobile device for configuring various parameters that may be used in method 100. The UI element 210 permits a user to select a preferred calendar that will be used in connection with the method 100. When a user clicks on the drop-down menu, the menu shows the various calendars available on the mobile device. The calendar selected in the drop-down menu is the calendar where the captured events will be stored. Although a drop-down menu is depicted, it will be understood that various form tools may be used to perform this function. For example, UI element 210 could be in the form of a combo box, command or radio buttons, a text box, or other such forms known in the art.

Also shown in FIG. 3, the UI form has several UI elements which may be selected and which indicate which events the user prefers to track using method 100. For example, if UI element 220 is selected, method 100 will capture events related to phone calls on the mobile device. Likewise, if UI element 230 is selected, method 100 will capture events related to emails, and if UI element 240 is selected, method 100 will capture text message events. Although three events to track UI elements are depicted, it will be known that some or all of these UI elements could be omitted from the UI form depicted in FIG. 3. Additionally, it will be understood that other UI elements could be included which would allow the user to track other events on the mobile device. For example, there could be included on the UI form a UI element to capture word processing type events. Additionally, although the UI elements 220, 230 and 240 are depicted as check boxes, it will be understood that various form tools may be used to perform this function. For example, these UI elements 220, 230 and 240 could be in the form of a drop down box, combo box, command or radio buttons, text box, or other such forms known in the art.

The UI form in FIG. 3 also includes various timing parameters which may be set by the user for use by method 100 in capturing the various events. In the preferred embodiment, UI element 250 allows the user to set the time desired for the capture fence. UI element 260 allows the user to set the minimum time increment the user prefers for method 100 to capture. Additionally, UI element 270 allows the user to set the minimum time multiple the user prefers to be used by method 100. Although three timing parameter UI elements are depicted, it will be known that some or all of these UI elements could be omitted from the UI form depicted in FIG. 3. Moreover, although the UI elements 250, 260 and 270 are depicted as counter or ticker boxes, it will be understood that various form tools may be used to perform this function. For example, these UI elements 250, 260 and 270 could be in the form of drop down boxes, combo boxes, command or radio buttons, text boxes, or other such forms known in the art.

Once the desired configuration is selected, the user can then select the UI element 280 to save the configuration and start to capture events via method 100. Alternatively, the user may select UI element 290 to cancel the configuration. In the preferred embodiment, if UI element 290 is selected, the configuration will be reset to the prior configuration set by the user. Alternatively, if UI element 290 is selected, the form is reset so that method 100 will not be enabled on the mobile device to capture any events.

Although the present invention has been described with reference to particular embodiments, persons skilled in the art will recognize that changes may be made in form and detail without departing from the spirit and scope of the invention.

What is claimed is:

1. A method to capture parameters related to billable events for the purpose of posting such information to an accounting system, the method comprising the steps of:
capturing a plurality of parameters for the event, wherein one of the parameters is an elapsed time of the event;
identifying whether a capture fence applies to the event;
permitting the modification of each of the plurality of parameters; and
storing the event where the elapsed time is greater than the capture fence.

2. A method to capture parameters related to billable events for the purpose of posting such information to an accounting system, the method comprising the steps of:
waiting for the occurrence of a first trigger;
capturing the elapsed time between the occurrence of the first trigger and the occurrence of a second trigger;
comparing the elapsed time with a capture fence;
determining whether the event should be saved to the accounting system;
rounding the value of the elapsed time up to the value of a minimum time increment;
rounding the value of the elapsed time up to the nearest minimum time multiplier; and
saving the billable events that should be saved to the accounting system.
